(19) United States
(12) Patent Application Publication
(10) Pub. No.: US 2010/0019736 A1
(43) Pub. Date: Jan. 28, 2010

(54) OSCILLATOR CIRCUIT

(75) Inventor: Toyokazu Katsumi, Kyoto (JP)

Correspondence Address: CANTOR COLBURN, LLP, 20 Church Street, 22nd Floor, Hartford, CT, 06103, US

(73) Assignee: ROHM CO., LTD., Kyoto (JP)

(21) Appl. No.: 12/146,973

(22) Filed: Jun. 26, 2008

(30) Foreign Application Priority Data
Jun. 27, 2007 (JP) JP2007-169392

(51) Int. Cl. H02J 7/00; H02J 15/00

(52) U.S. Cl. 320/166

(57) ABSTRACT

An oscillation circuit generates a pulse signal. A charging/discharging circuit performs switching between a charging state between a charging state for charging the capacitor and a discharging state for discharging the capacitor. A first to a third comparators compare a capacitor voltage with a first to a third voltages, and generates a first to a third signals corresponding to a comparison result. A control unit switches the charging/discharging circuit to a discharging state according to a first signal and switches the circuit to a charging state according to a second signal. A pulse generating unit generates a pulse signal which allows switching between a high level and a low level, based on either one of the first signal and the second signal, and the third signal in a charging state. The charging/discharging circuit can adjust discharging current while charging current is fixed.

### BACKGROUND OF THE INVENTION

1. Field of the Invention

The present invention relates to an oscillator circuit which generates a pulse signal.

2. Description of the Related Art

A semiconductor integrated circuit uses a pulse signal as a clock signal which synchronizes operations between circuit blocks. A typical power supply unit, for example, for a switching regulator or a charge pump circuit uses a pulse signal to switch on/off operations of a switching device.

Japanese Patent Application (Laid-Open) No. H1-243707 has disclosed an oscillator circuit which alternately repeats charging and discharging to a capacitor to generate a triangular wave signal, and slices the triangular wave signal at a predetermined level to generate a pulse signal based on intersections thereof.

### SUMMARY OF THE INVENTION

In view of such states, it is a general purpose of the present invention to provide an oscillator circuit capable of changing only frequencies with a pulse width fixed.

According to an embodiment of the present invention, an oscillator circuit includes: a capacitor; a charging/discharging circuit which performs switching between a charging state of charging the capacitor and a discharging state of discharging the capacitor; a first comparator which compares a voltage of the capacitor with a first voltage and generates a first signal corresponding to a comparison result; a second comparator which compares a voltage of the capacitor with a second voltage lower than the first voltage and generates a second signal corresponding to a comparison result; a third comparator which compares a voltage of the capacitor with a third voltage between the first voltage and the second voltage and generates a third signal corresponding to a comparison result; a control unit which receives the first and the second signals, switches a charging/discharging circuit to a discharging state corresponding to the first signal and switches the charging/discharging circuit to a charging state corresponding to the second signal; and a pulse generation unit which generates a pulse signal which allows switching between a high level and a low level based on either one of the first signal and the second signal and a third signal in a charging state. The charging/discharging circuit can adjust discharging current while charging current is fixed.

In another embodiment, the pulse generation unit may generate a pulse signal which allows switching between a high level and a low level based on either one of the first signal and the second signal and a third signal in a discharging state. At this time, the charging/discharging circuit can adjust charging current while discharging current is fixed.

Each of these embodiments generates a triangular wave signal having a first voltage in a peak state and a second voltage in a bottom state. By adjusting either one of charging current and discharging current, only an inclination of an up slope or a down slope of the triangular wave signal is adjusted, and cycle duration, that is, frequency can be changed. At this time, by adjusting either one of charging current and discharging current and fixing the other, an inclination of a slope for generating a pulse signal can be kept constant, thus fixing a pulse width.

An oscillator circuit in an embodiment may further include a frequency setting unit which receives a signal for setting a frequency and sets an adjustable discharging current or a charging current to an electric current value corresponding to a preset frequency.

This embodiment allows an optional change of a frequency with the pulse width fixed, and is suitably applicable to pulse frequency modulation (PFM) and pulse density modulation (PDM).

Further embodiment of the present invention relates to a method for generating a pulse signal. This method includes: generating a triangular wave signal by repeating charging and discharging of a capacitor; comparing two slice level to be set in the course of either one of an up slope or a down slope of the triangular wave signal with a voltage level of the triangular wave signal; generating a pulse signal which is kept at a predetermined level until the voltage level of the triangular wave signal reaches a second slice level after reaching a first slice level; and changing either one of the charging current and the discharging current to the capacitor to change an inclination of a remaining slope which does not allow setting of the two slice level.

One of the two slice levels may be a threshold voltage for setting a triangular wave signal to a peak voltage or bottom voltage.

It is to be noted that any arbitrary combination or rearrangement of the above-described structural components and so forth is effective as and encompassed by the present embodiments.

Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a circuit diagram illustrating a configuration of an oscillator circuit according to an embodiment of the present invention; and

FIG. 2 is an operation waveform plot of an oscillator circuit in FIG. 1.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

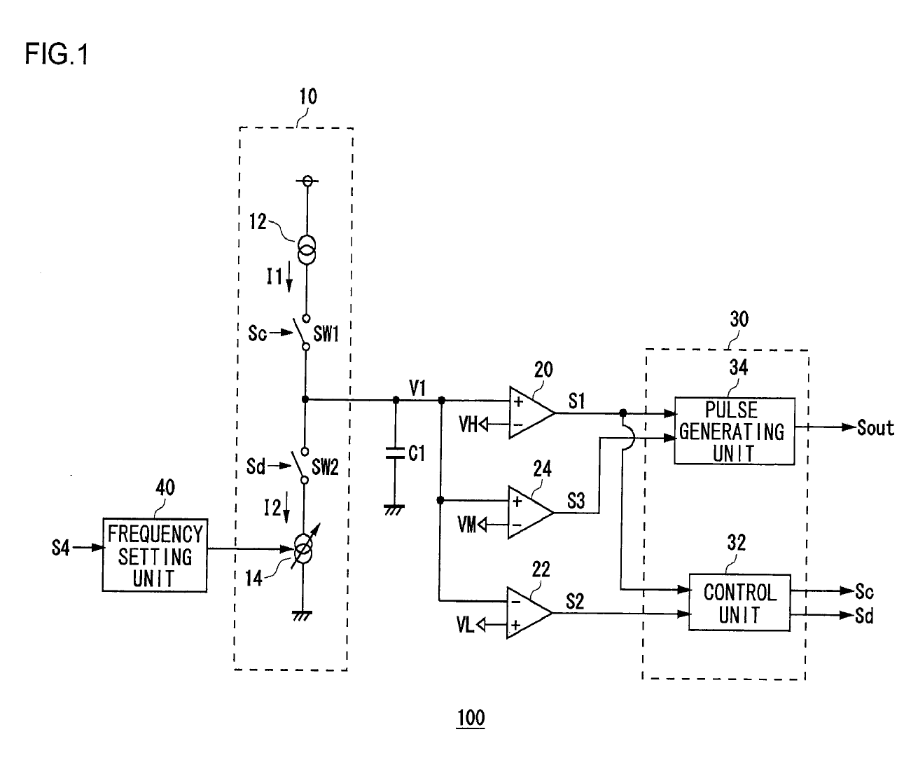

FIG. 1 is a circuit diagram illustrating a configuration of an oscillator circuit 100 according to an embodiment of the present invention. The oscillator circuit 100 includes a capacitor C1, a charging/discharging circuit 10, a first comparator 20, a second comparator 22, a third comparator 24, a logic unit 30 and a frequency setting unit 40. The oscillator circuit 100 repeats charging and discharging operations for the capacitor C1 to generate a triangular wave signal V1. In addition, a triangular wave signal V1 is compared with a predetermined slice level to generate a pulse signal Sout.

One end of the capacitor C1 is grounded, which keeps a potential thereof fixed. The charging/discharging circuit 10 performs alternate switching between a charging state φ1 for charging and a discharging state φ2 for discharging the capacitor C1. When the capacitor C1 is charged by a charging current I1, a voltage V1 at the other end of the capacitor C1 increases with time. On the contrary, when the capacitor C1 is discharged by a discharging current I2, the voltage V1 decreases with time. Repeating the charging state φ1 and the discharging state φ2 makes a voltage of the capacitor C1, hereinafter referred to as “capacitor voltage V1”, into a triangular wave.

The charging/discharging circuit 10 includes a first electric current source 12, a second electric current source 14, a first switch SW1 and a second switch SW2. The current source 12 generates a charging current I1 and the second current source 14 generates a discharging current I2. The first switch SW1 and the second switch SW2 are respectively provided on a path for charging current I1 and discharging current I2. On-off operations of the first switch SW1 and the second switch SW2 are switched by control signals Sc, Sd, which will be described later. The first switch SW1 and the second switch SW2 are on/off controlled exclusively and alternately.

The first comparator 20 compares a capacitor voltage V1 with a first voltage, hereinafter referred to as a “peak voltage VH”, and generates a first signal S1 corresponding to a comparison result. The first signal S1 is a signal indicating that a capacitor voltage V1 has raised to a peak voltage VH. The second comparator 22 compares a capacitor voltage V1 with a second voltage lower than a peak voltage VH, hereinafter referred to as a “bottom voltage VL” and generates a second signal S2 corresponding to a comparison result. The second signal S2 is a signal indicating that the capacitor voltage V1 drops to the bottom voltage VL. The third comparator 24 compares a capacitor voltage V1 with a third voltage between a peak voltage VH and the bottom voltage VL, hereinafter referred to as “slice voltage VM” and generates a third signal S3 corresponding to a comparison result.

The logic unit 30 receives a first signal S1 to a third signal S3. The logic unit 30 performs switching between charging and discharging states of the charging/discharging circuit 10 based on the first signal S1 to the third signal S3 and outputs a pulse signal Sout having a predetermined pulse width.

The logic unit 30 includes a control unit 32 and a pulse generating unit 34. To the control unit 32, a first signal S1 and a second signal S2 are input. The control unit 32, when detecting that a capacitor voltage V1 reaches a peak voltage VH with a first signal S1, switches off the first switch SW1 with a control signal Sc and switches on the second switch SW2 with a control signal Sd. As a result, the charging/discharging circuit 10 is set to a discharging state φ2. On the contrary, the control unit 32, when detecting that a capacitor voltage V1 reaches a bottom voltage VL with a first signal S1, switches on the first switch SW1 with a control signal Sc and switches off the second switch SW2 with a control signal Sd. As a result, the charging/discharging circuit 10 is set to a charging state φ1. Hence, a capacitor voltage V1 makes into a triangular wave signal having a peak voltage VH and a bottom voltage VL at a summit thereof.

The pulse generating unit 34 generates a pulse signal Sout which allows switching between a high level and a low level, based on either one of a first signal S1 and the second signal S2 and a third signal S3 in a charging state. The pulse generating unit 34 generates a pulse signal Sout based on a first signal S1 and a third signal S3. Specifically, the pulse generating unit 34 generates a pulse signal Sout which allows level switching at such a first timing that a capacitor voltage V1 intersects with a slice voltage VM and such a second timing that the capacitor voltage V1 reaches a peak voltage VH.

The pulse generating unit 34 may generate a pulse signal Sout based on a second signal S2 and a third signal S3. In this case, the pulse generating unit 34 generates a pulse signal Sout which allows level switching at such a first timing that a capacitor voltage V1 drops to a bottom voltage VL and such a second timing that the capacitor voltage V1 intersects with a slice voltage VM under a charging state φ1.

The charging/discharging circuit in FIG. 1 is configured so that discharging current I2 is adjustable with a charging current I1 fixed. Specifically, the first current source 12 is a constant current source and the second current source 14 is a variable current source. A charging current I1 by the first current source 12 may be adjustable, but should be configured to be adjustable independently of the second current source 14.

The frequency setting unit 40 receives a setting signal S4 for setting an oscillation frequency of the oscillator circuit 100 from the outside. In addition, the frequency setting unit 40 sets an adjustable discharging current I2 to an electric current value corresponding to the setting signal S4. The charging current I1 is fixed to a fixed value regardless of a preset frequency.

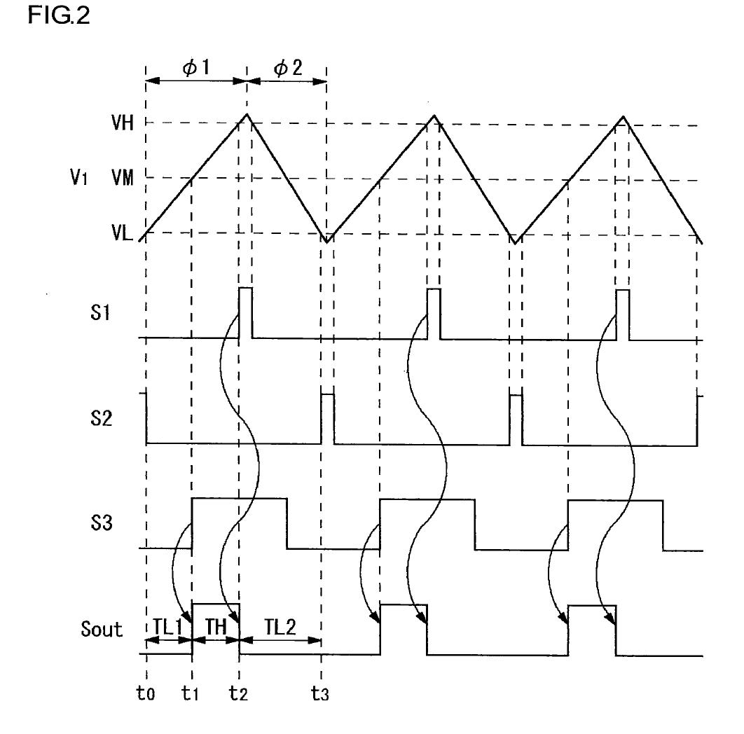

Operation of the oscillator circuit 100 in FIG. 1 configured in the above way will be described below. FIG. 2 is an operation waveform plot of an oscillator circuit in FIG. 1. At a time t0, the charging/discharging circuit 10 is set to a charging state φ1 and a capacitor voltage V1 starts to rise. At a time t1, when an up slope of a capacitor voltage V1 intersects with a slice voltage VM, a third signal S3 is kept at a high level. The pulse generating unit 34, receiving a positive edge of the then third signal S3, keeps a pulse signal Sout at a high level. At a time t2, when the capacitor voltage V1 reaches a peak voltage VH, a first signal S1 is kept at a high level. Hence, the control unit 32 switches the charging/discharging circuit 10 to a discharging state φ2. At the same time, the pulse generating unit 34 keeps a pulse signal Sout at a low level according to a positive edge of a first signal S1. At a time t3, when a capacitor voltage V1 drops to a bottom voltage VL, a second signal S2 is kept at a high level, and the control unit 32 switches the charging/discharging circuit 10 to a charging state φ1.

By repeating charging and discharging operations with times t0 to t3 taken as one cycle, a pulse signal Sout can be generated. In the case of the oscillator circuit 100 in FIG. 1, a charging current I1 is fixed and only a discharging current I2 is adjustable. When only a discharging current T2 is changed, an inclination of a down slope at times t2 to t3 is adjusted with an inclination of an up slope fixed at times t0 to t2 in FIG. 2. Accordingly, a period TL1 at times t0 to t1 and a period TH at times t1 to t2 are kept constant and a period TL2 at times t2 to t3 change with a discharging current I2.

A cycle of a pulse signal Sout is TL1+TL2+TH and therefore, by changing a discharging current I2, frequency can be changed. On the other hand, a period TH does not depend upon a discharging current I2, and a pulse signal Sout is kept constant during at a high level. Hence, the oscillator circuit 100 can adjust frequency while a pulse width TH is fixed.

It is further understood by those skilled in the art that the foregoing description is a preferred embodiment of the disclosed oscillator circuit and that various changes and modifications may be made in the invention without departing from the spirit and scope thereof. Illustration thereof will be made below.

The circuit in FIG. 1 illustrates a case where a pulse signal Sout is generated using an up slope of a capacitor voltage V1, but the present invention is not limited thereto and the pulse signal may be generated using a down slope of the capacitor voltage V1. In this case, it is sufficient for the pulse generating unit 34 to generate a third signal S3 in a discharging state, that is, the pulse signal Sout using a negative edge of the third signal S3 in FIG. 2. Otherwise, a polarity of an input terminal of the third comparator 24 may be set to be reverse. Further, the charging/discharging circuit 10 may adjust charging current I1 while discharging current I2 is fixed.

FIG. 1 illustrates a configuration in which a first switch SW1 and a second switch SW2 are provided for both of a charging path and a discharging path of the charging/discharging circuit 10, but the present invention is not limited thereto. For example, a configuration having no second switch SW2 may be used to be I1>I2. In this case, when the first switch SW1 is on, a charging state φ1 is made, and a net charging current is I1-I2. On the contrary, when the first switch SW1 is off, a discharging state is made, and a net discharging current is I2. With this configuration, by making only the charging current I1 adjustable and producing the pulse signal Sout using a down slope of the capacitor voltage V1, only a frequency can be changed while a pulse width is fixed in the same way as the circuit in FIG. 1. On the contrary, by making a configuration having no first switch SW1 to be set at I1<I2, the pulse signal Sout may be generated using an up slope of the capacitor voltage V1.

The frequency adjustment technique described in the embodiment may be applicable to frequency calibration in addition to an application of positively making a frequency change in the same way as in pulse modulation. Specifically, the oscillator circuit 100 according to an embodiment of the present invention can independently adjust a charging current I1 and a discharging current I2 and therefore, first, either one of the two currents may be adjusted to set a pulse width to a desired value and then the remainder thereof may be adjusted to bring a frequency next to a desired value.

The embodiment described above has described a high level period of the pulse signal Sout as a pulse width, but a low level period may be taken as a pulse width and a frequency may be made variable with the pulse width fixed. In this case, it is sufficient to reverse the embodiment and a logic level as needed.

By abstracting or preferentially conceptualizing a pulse generation technique described in the circuit of FIG. 1 and the deformed example thereof, the following technical philosophy is obtained. In the technical philosophy, the following operations are executed:

(1) Operations for charging and discharging the capacitor are repeated to generate a triangular wave signal.

(2) Two slice levels to be set in the course of either one of an up slope or a down slope of the triangular wave signal are compared with a voltage level of the triangular wave signal. A term “in the course” above includes both ends (ie peak and bottom) of the slope.

(3) A pulse signal which is a predetermined level is generated until the voltage level of the triangular wave signal reaches a second slice level from upon reaching a first slice level.

(4) Either one of a charging current and a discharging current to a capacitor is verified to change a slope inclination of the remainder in which the two slice levels are not defined. This technical philosophy enables a frequency change while a period in which a pulse signal is at a predetermined level, that is, a pulse width is fixed.

When the technical philosophy is related to the circuit of FIG. 1, the triangular wave signal meets a capacitor voltage V1. The two slice levels are compatible with a slice voltage VM and a first voltage VH. In the circuit of FIG. 1, one of the two slice levels is shared with a peak voltage VH of the capacitor voltage V1 to simplify the circuit. The first voltage VH may be separately provided between VM and VH without need of being shared with the peak voltage of the triangular wave signal.

The charging/discharging circuit 10 in FIG. 1 includes a first switch SW1 and a second switch SW2 on paths of a charging current I1 and a discharging current I2, but the present invention is not limited thereto. For example, by forcibly turning off transistors constituting a first current source 12 and a second current source 14, a charging state φ1 and a discharging state φ2 may be switched.

While the preferred embodiments of the present invention have been described using specific terms, such description is for illustrative purposes only, and it is to be understood that changes and variations may be made without departing from the spirit or scope of the appended claims.

What is claimed is:

1. An oscillator circuit comprising:
a capacitor;
a charging/discharging circuit which performs switching between a charging state of charging the capacitor and a discharging state of discharging the capacitor;
a first comparator which compares a voltage of the capacitor with a first voltage and generates a first signal corresponding to a comparison result;
a second comparator which compares a voltage of the capacitor with a second voltage lower than the first voltage and generates a second signal corresponding to a comparison result;
a third comparator which compares a voltage of the capacitor with a third voltage between the first voltage and the second voltage and generates a third signal corresponding to a comparison result;
a control unit which receives the first and the second signals, switches a charging/discharging circuit to a discharging state corresponding to the first signal and switches the charging/discharging circuit to a charging state corresponding to the second signal; and
a pulse generation unit which generates a pulse signal which allows switching between a high level and a low level based on either one of the first signal and the second signal and a third signal in a charging state, wherein
the charging/discharging circuit can adjust discharging current while charging current is fixed.

2. An oscillator circuit comprising:
a capacitor;
a charging/discharging circuit which performs switching between a charging state of charging the capacitor and a discharging state of discharging the capacitor;
a first comparator which compares a voltage of the capacitor with a first voltage and generates a first signal corresponding to a comparison result;
a second comparator which compares a voltage of the capacitor with a second voltage lower than the first voltage and generates a second signal corresponding to a comparison result;
a third comparator which compares a voltage of the capacitor with a third voltage between the first voltage and the second voltage and generates a third signal corresponding to a comparison result;
a control unit which receives the first and the second signals, switches a charging/discharging circuit to a discharging state corresponding to the first signal and switches the charging/discharging circuit to a charging state corresponding to the second signal; and
a pulse generation unit which generates a pulse signal which allows switching between a high level and a low level based on either one of the first signal and the second signal and a third signal in a charging state, wherein
the charging/discharging circuit can adjust charging current while discharging current is fixed.

3. The oscillator circuit according to claim 1, further comprising a frequency setting unit which receives a signal for setting a frequency and sets an adjustable discharging current or a charging current to an electric current value corresponding to a preset frequency.

4. The oscillator circuit according to claim 2, further comprising a frequency setting unit which receives a signal for setting a frequency and sets an adjustable discharging current or a charging current to an electric current value corresponding to a preset frequency.

5. A method for generating a pulse signal comprising:
generating a triangular wave signal by repeating charging and discharging of a capacitor;
comparing two slice level to be set in the course of either one of an up slope or a down slope of the triangular wave signal with a voltage level of the triangular wave signal;
generating a pulse signal which is kept at a predetermined level until the voltage level of the triangular wave signal reaches a second slice level after reaching a first slice level; and
changing either one of the charging current and the discharging current to the capacitor to change an inclination of a remaining slope which does not allow setting of the two slice level.
